(19) United States
(12) Patent Application Publication
(10) Pub. No.: US 2010/0229807 A1
(43) Pub. Date: Sep. 16, 2010

(54) FUEL CONSUMPTION REDUCTION APPARATUS

(76) Inventor: JEN-SHENG LUNG, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/566,998

(22) Filed: Sep. 25, 2009

(30) Foreign Application Priority Data
Mar. 10, 2009 (TW) 097138045

(51) Int. Cl. F02B 43/08

(52) U.S. Cl. 123/3

(57) ABSTRACT

A fuel consumption reduction apparatus is implemented in an automobile and utilizes a magnetic device to magnetize fuel oil within a fuel pipe. Besides, the apparatus also utilizes an electrolytic device to decompose water into oxygen and hydrogen gases. Then, the oxygen gas generated from the electrolytic device and magnetized fuel oil are introduced into an engine. Because the oxygen gas and the magnetized fuel oil respectively have opposite charges, fuel combustion is much more perfect and fast. Then, power from fuel combustion is significantly increased. The present invention brings a less damage against environment in addition to energy saving and power increase.

### BACKGROUND OF THE INVENTION

(1) Field of the Invention

The invention relates to a fuel consumption reduction apparatus, and more in particular to an apparatus which is implemented in fuel-driven transportation vehicle so as to reduce fuel consumption.

(2) Description of the Prior Art

Because crude oil resources dry up and energy crisis is higher, oil price is also higher and high oil consumption devices do not only cost a fortune but also greenhouse gas is generated due to incomplete fuel combustion. The greenhouse gas may be a much more devastating factor than energy crisis.

Fuel-powered engines are mainstreams of power sources. For example, automobile, trains or airplane are propelled by fuel-powered engines. Oil reserve is limited on earth, and oil is consumed overly so that oil reserve is becoming much scarce. In addition, fuel combustion will bring about waste and leads to environmental pollution and ecological damage.

In the light of this, a variety of ways how to reduce oil consumption are invented and particularly applied in automobiles. Automobiles are the largest group of fuel-consumption apparatus or vehicles. To resolve fuel consumption of automobiles, quite a few new technologies are developed to generate alternate energy such as solar energy vehicles, or electric vehicles. Taiwan Utility Patent M332599 discloses a wind-powered electric vehicle, and however, there are two disadvantages. Firstly, the technology is still not mature, and vehicles implemented with this technology are not widely available in the market or cost is still high. Secondly, existing fuel-powered vehicles may not be converted to new vehicles with new technology. So, automobile makers are reluctant to invest this fuel-economy technology, and consumers are not willing to purchase this kind of vehicles.

Thus, some newly developed technologies meet consumers' needs in market so that existing fuel-powered vehicles can be directly converted so as to reduce fuel consumption. For example, Taiwan Utility Patents M327923 and M315259 utilize radiator to adjust oxygen molecules in inlet gas so as to improve combustion efficiency. Besides, Taiwan Utility Patents M313170 and M245085 utilizes electrolysis to generate and introduce hydrogen and oxygen gases into engine so that hydrogen and oxygen gases are mixed with fuel. Taiwan Utility Patents M304580 and M248908 magnetize fuel so as to improve combustion efficiency, and M295694 magnetizes infra-red throttle oil ball. Taiwan Utility Patents M261597 magnetizes inlet gas so as to increase combustion efficiency. These technologies have been extensively developed so that this is a crowded field of technology. From experiments, the above-described methods are capable of reducing fuel consumption but these methods are not perfect and it is necessary to explore an optimal method.

Therefore, the present invention provides a fuel consumption reduction apparatus which is implemented in a fuel-driven transportation vehicle so as to reduce fuel consumption and overcome the above disadvantages.

### SUMMARY OF THE INVENTION

Accordingly, it is an object of the present invention to provide a fuel consumption reduction apparatus which is implemented in a fuel-driven transportation vehicle so as to reduce fuel consumption. The present invention leads to much higher combustion efficiency and brings a less damage against environment. Besides, according to the present invention, existing fuel-powered vehicles can be directly converted in an oil-economy and low-cost way. Thus, automobile makers and consumers' are much more willing to embrace this product so as to achieve environmental protection and energy conservation.

The present invention relates to a fuel consumption reduction apparatus which is implemented in a machine and used to power the machine. The fuel consumption reduction apparatus includes an engine, a fuel pipe, a magnetic device, an electrolytic device, and an oxygen gas inlet pipe.

The engine consumes fuel to generate power. The fuel pipe is used to introduce the fuel into the engine, and the magnetic device is implemented at the fuel pipe so as to magnetize the fuel within the fuel pipe.

With electrolysis, the electrolytic device is used to decompose water into oxygen and hydrogen gases. The oxygen gas inlet pipe is used to introduce the oxygen gas into the engine so as to support consuming the fuel oil.

Therefore, the present invention utilizes the fuel consumption reduction apparatus which is implemented in fuel-driven transportation vehicle, and the present invention also utilizes synchronization between the magnetic device and the electrolytic device so as to achieve perfect combustion and bring less damage against environment. Besides, existing fuel-powered vehicles can be directly converted in an oil-economy and low-cost way. Thus, automobile makers and consumers' are much more willing to embrace this product so as to achieve environmental protection and energy conservation.

### BRIEF DESCRIPTION OF THE DRAWINGS

The present invention will now be specified with reference to its preferred embodiment illustrated in the drawings, in which:

FIG. 1 is a perspective view of a fuel consumption reduction apparatus according to the present invention;

FIG. 2 is a perspective view of a fuel consumption reduction apparatus including fuel cells according to the present invention;

FIG. 3 is a perspective view of a magnetic device which is implemented at a fuel pipe according to the present invention; and

FIG. 4 is a perspective view of a magnetic device which is implemented at an oxygen gas inlet pipe according to the present invention.

### DESCRIPTION OF THE PREFERRED EMBODIMENT

In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

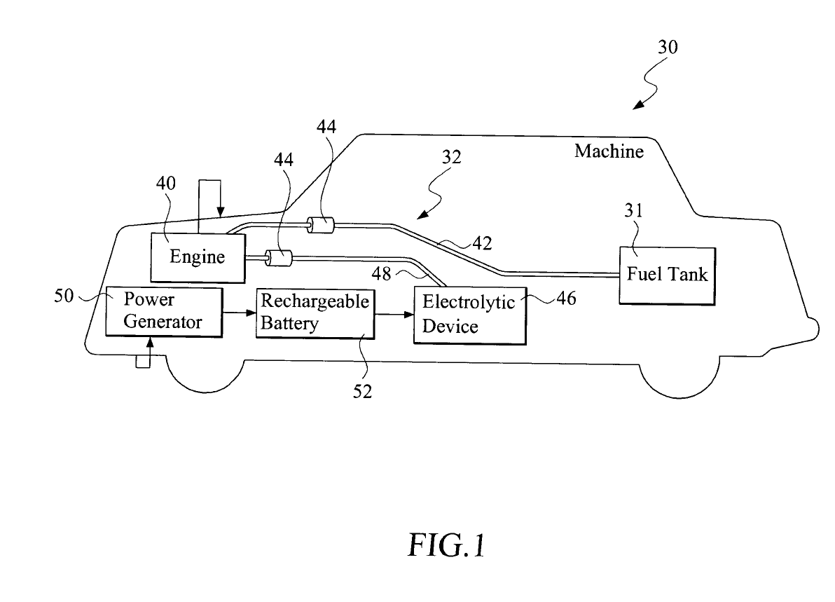

Referring to FIG. 1, it illustrates a perspective view of a fuel consumption reduction apparatus 32 according to the present invention. The present invention relates to the fuel consumption reduction apparatus 32 which is implemented at a machine 30 and used to power the machine 30. The machine 30 can be any fuel-driven vehicles such as motorcycles, automobiles, airplanes or includes a fuel-propelled engine to generate power. The fuel consumption reduction apparatus 32 includes an engine 40, a fuel pipe 42, a magnetic device 44, an electrolytic device 46, and an oxygen gas inlet pipe 48.

Fuel oil is stored at the fuel tank 31, and the fuel pipe 42 is used to introduce fuel oil into the engine 40. The magnetic device 44 is implemented at the fuel pipe 42 so as to magnetize the fuel oil within the fuel pipe 42. Magnetized fuel oil has smaller molecules and is prone to be burned, and molecules of fuel oil have negative charges because N poles of the magnetic device are in proximity with the fuel pipe 42. These molecules with negative charges expel one another and are uniformly distributed so that magnetized fuel oil is perfectly combusted because the magnetized fuel oil is in contact with support combustion gas. Then, magnetized fuel oil is introduced into the engine 40 so that magnetized fuel oil is combusted to power the machine 30.

The electrolytic device 46 utilizes two electrodes and electrolyte dissolved in water to quickly decompose water into oxygen and hydrogen gases by the law of electrolysis. The oxygen gas inlet pipe 48 is used to introduce oxygen gas from electrolysis into the engine 40 so as to support combust the magnetized fuel oil. It is preferred that another magnetic device 44 is implemented at the oxygen gas inlet pipe 48 so that oxygen gas within the oxygen gas inlet pipe 48 is ionized. The ionized oxygen gas has positive charge so that fuel combustion is much more perfect and fast because oxygen gas and fuel molecules respectively have opposite charges. Then, power from fuel combustion is significantly increased. Therefore, the present invention brings a less damage against environment and reduces carbon emission in addition to energy conservation and power increase.

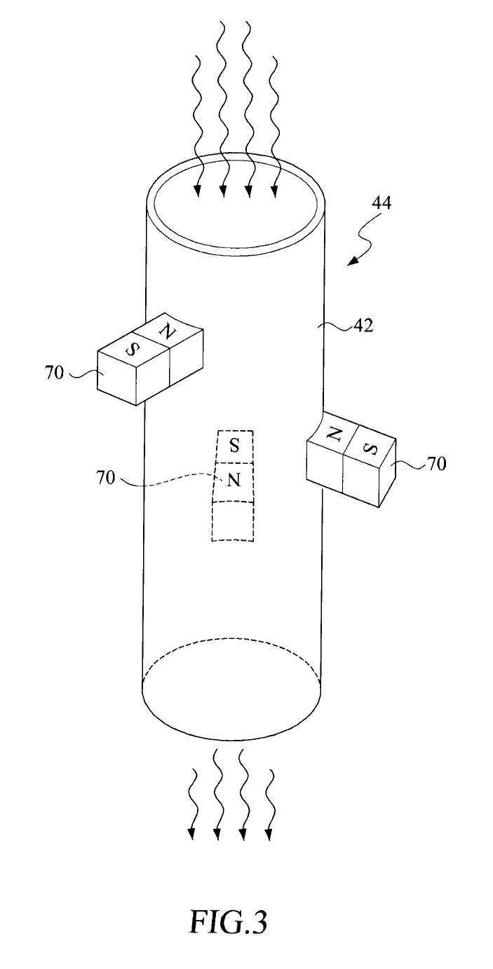

From experiment data, the machine with the magnetic device 44 (shown in FIG. 3 and detailed descriptions) of the present invention has saved more fuel consumption up to 25% than the machine without magnetic device. If the magnetic device 44 co-operates with the electrolytic device 46, then the machine with the magnetic device 44 of the present invention has saved more fuel consumption up to 40% than the machine without magnetic device. It is estimated that cost to convert existing fuel-powered vehicles saves more 50% than the prior art. Thus, the fuel consumption reduction apparatus 32 of the present invention is indeed inventive.

Furthermore, the machine 30 further includes a power generator 50 and a rechargeable battery 52. For automobiles, the power generator 50 and the rechargeable battery 52 are original equipments. The power generator 50 utilizes the machine 30 to generate electricity, and as for automobiles, electricity is generated when the automobiles moves. The rechargeable battery 52 such as 12-V battery of the automobiles stores electricity generated by power generator 50.

When the rechargeable battery 52 is charged to a pre-determined volt such as 100% of capacity, redundant electricity will be supplied to the electrolytic device 46. Thus, the electrolysis device 46 does not consume electricity by consuming fuel oil, and only redundant electricity helps electrolysis. That is what we called “energy conservation”.

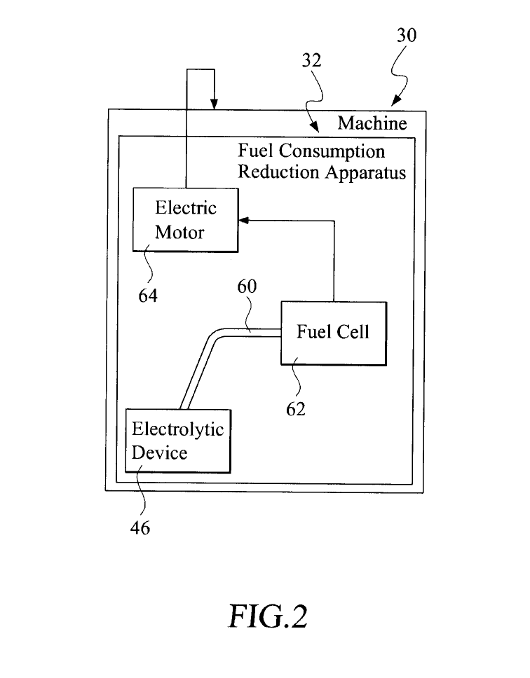

Besides, referring to FIG. 2, it illustrates a perspective view of a fuel consumption reduction apparatus 32 including a fuel cell 62 according to the present invention. The fuel consumption reduction apparatus 32 also includes a hydrogen gas inlet pipe 60, a fuel cell 62, and an electric motor 64.

The electrolytic device 46 also provides hydrogen gas, and the hydrogen gas inlet pipe 60 introduces the hydrogen gas from the electrolytic device 46 into the fuel cell 62. The fuel cell 62 uses the hydrogen gas from the electrolytic device 46 as fuel so as to generate electricity. The electricity generated by the fuel cell 62 will be supplied to the electric motor 62, and when the electric motor 64 is powered by electricity from the fuel cell 62, the electric motor 64 generates more energy to the machine 30. If the automobiles use power or energy from the electric motor 64 and combustion of fuel oil, then the automobiles are hybrid electric vehicles in consumers' market. However, the present invention does not exist in prior art and is distinguished and inventive.

Referring to FIG. 3, it illustrates a perspective view of the magnetic device 44 which is implemented at the fuel pipe 42 according to the present invention. The magnetic device 44 of the fuel consumption reduction apparatus 32 includes at least three magnetic objects 70, and is mainly applied at transportation vehicles. It is preferred that the magnetic objects 70 are permanent magnets. The magnetic objects 70 are implemented in proximity with perimeter of the fuel pipe 42 and along a helical path. Parts of the magnetic objects 70 with same magnetic pole are oriented toward the fuel pipe 42 so as to magnetize the fuel oil within the fuel pipe 42. In particular, the fuel oil will have negative charges, and it is preferred that inner area in proximity with N pole has negative charges. The magnetic objects 70 are implemented along helical path so that magnetic flux uniformly and helically penetrates through fuel oil within the fuel pipe 42. Thus, optimal magnetic performance is achieved.

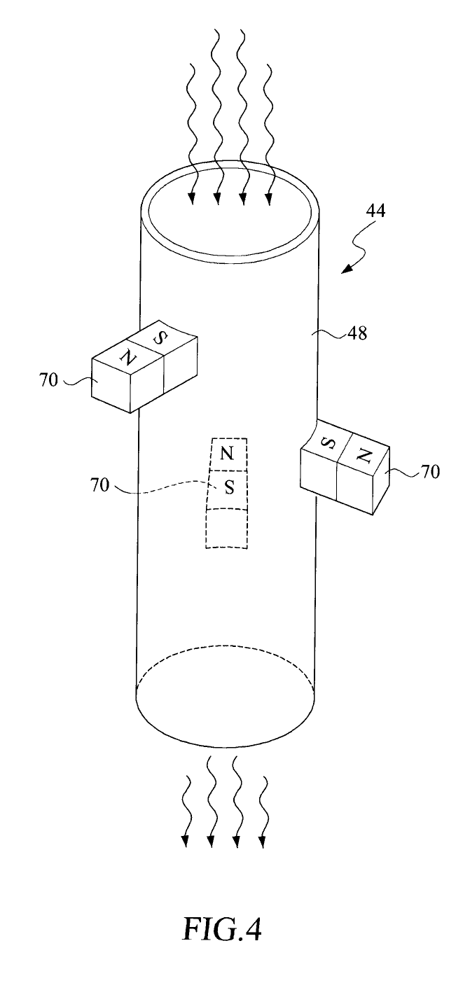

Referring to FIG. 4, it illustrates a perspective view of the magnetic device 44 which is implemented at the oxygen gas inlet pipe 48 according to the present invention. The magnetic device 44 of the fuel consumption reduction apparatus 32 includes at least three magnetic objects 70, and mainly is applied at transportation vehicles. It is preferred that the magnetic objects 70 are permanent magnets. The magnetic objects 70 are implemented in proximity with perimeter of the oxygen gas inlet pipe 48 and along a helical path. Parts of the magnetic objects 70 with same magnetic pole are oriented toward the oxygen gas inlet pipe 48 so as to magnetize the oxygen gas within the oxygen gas inlet pipe 48. In particular, the oxygen gas will have positive charges, and it is preferred that inner area in proximity with S pole has positive charges. Because the magnetic objects 70 are helically implemented, so that magnetic flux uniformly and helically penetrates through oxygen gas within the oxygen gas inlet pipe 48. Thus, oxygen gas will be ionized and has positive charges due to magnetic flux.

Therefore, the present invention utilizes the fuel consumption reduction apparatus 32 which is implemented in fuel-driven transportation vehicle, and the present invention also utilizes synchronization between the magnetic device 44 and the electrolytic device 46 so as to increase combustion efficiency and bring less damage against environment. Besides, existing fuel-powered vehicles can be directly converted in an oil-economy and low-cost way. Thus, automobile makers and consumers' are much more willing to embrace this product so as to achieve environmental protection and energy conservation.

While the present invention has been particularly shown and described with reference to a preferred embodiment, it will be understood by those skilled in the art that various changes in form and detail may be without departing from the spirit and scope of the present invention.

I claim:

1. A fuel consumption reduction apparatus which is implemented in a machine and used to power the machine, comprising:
an engine, consuming fuel to generate power;
a fuel pipe, used to introduce the fuel oil into the engine;
a magnetic device, implemented at the fuel pipe so as to magnetize the fuel oil within the fuel pipe;
an electrolytic device, used to decompose water into oxygen and hydrogen gases; and
an oxygen gas inlet pipe, used to introduce the oxygen gas into the engine so as to support consuming the fuel oil.

2. The fuel consumption reduction apparatus according to claim 1, further comprising:
a power generator, utilizing the machine to generate electricity; and
a rechargeable battery, storing electricity generated by power generator;
wherein electricity is supplied to the electrolytic device when the rechargeable battery is charged to a pre-determined value.

3. The fuel consumption reduction apparatus according to claim 1, further comprising:
a hydrogen gas inlet pipe, used to introduce the hydrogen gas from the electrolytic device;
a fuel cell, using the hydrogen gas from the electrolytic device as fuel so as to generate electricity; and
an electric motor, receiving electricity generated by the fuel cell so that more energy is generated to power the machine.

4. The fuel consumption reduction apparatus according to claim 1, wherein the machine is a fuel-driven transportation vehicle.

5. The fuel consumption reduction apparatus according to claim 4, wherein the fuel-driven transportation vehicle is an automobile.

6. The fuel consumption reduction apparatus according to claim 1, wherein the magnetic device includes at least three magnetic objects which are implemented in proximity with perimeter of the fuel pipe and along a helical path, and parts of the magnetic objects with same magnetic pole are oriented toward the fuel pipe so as to magnetize the fuel oil within the fuel pipe.

7. The fuel consumption reduction apparatus according to claim 1, wherein another magnetic device is implemented at the oxygen gas inlet pipe so that oxygen gas within the oxygen gas inlet pipe is ionized.
